(19) United States
(12) Patent Application Publication
(10) Pub. No.: US 2007/0002680 A1
(43) Pub. Date: Jan. 4, 2007

(54) Method of producing mixtures of thermally labile materials

(75) Inventors: David P. Vanderbilt, Webster, NY (US); Bradley Adams, Newport Richey, FL (US); Karen L. Walker, Rochester, NY (US); Horngyih Huang, Penfield, NY (US); Dominic V. Ruscio, Webster, NY (US)

Correspondence Address: Bausch & Lomb Incorporated, One Bausch & Lomb Place, Rochester, NY, 14604-2701, US

(73) Assignee: Bausch & Lomb Incorporated

(21) Appl. No.: 11/169,383

(22) Filed: Jun. 29, 2005

(51) Int. Cl. B01F 9/02

(52) U.S. Cl. 366/217

(57) ABSTRACT

A method of producing a mixture comprises providing, in a container, at least a first component of the mixture at a first temperature; adding a remaining component of the mixture to said at least a first component; subjecting the container to a rotational motion about a first axis in a first direction while rotating the container about a second axis in a second direction to effect a mixing; wherein the first temperature is lower than the temperature of the mixture at the end of the mixing.

### BACKGROUND OF THE INVENTION

The present invention relates to a method of producing mixtures of thermally labile materials. In particular, the present invention relates to a method of rapidly producing substantially uniform mixtures of thermally labile materials and of increasing work life of such mixtures.

Producing uniform mixtures is pervasively required in the chemical and pharmaceutical industries. Such mixtures often comprise thermally labile components that are brought together only shortly before a mixture is used. Therefore, it is desirable to minimize the mixing time of thermally labile components and to maximize the work life of the resulting mixture. The term “work life” means the time between the completion of the mixing and the time at which the mixture is changed to a degree that the mixture is no longer usable for the application.

Mixing of flowable materials, such as liquids, has conventionally been accomplished by rotating blades or vanes immersed in the materials. However, it is difficult to employ this method to mix highly viscous materials. Mixers for such materials require high-torque rotors and high input power. Even then, viscous materials still require long mixing times to ensure the production of uniform mixtures and materials at corners of the container still are not likely mixed well. Mixing thermally labile components is even more challenging because they are not amenable to withstand long mixing times.

Therefore, there is a continued need to provide methods for mixing thermally labile materials, which methods require short mixing times and produce uniform mixtures.

### SUMMARY OF THE INVENTION

In general, the present invention provides a method for producing mixtures of thermally labile materials.

In one aspect, a method of the present invention requires a shorter mixing time than conventional mixing methods and produces a mixture having longer work life.

In another aspect, the present invention provides a method for producing substantially uniform mixtures of polymerizable components.

In still another aspect, a method of the present invention comprises providing, in a container, at least a first component of the mixture at a first temperature; adding a remaining component of the mixture to said at least a first component; subjecting the container to a rotational motion about a first axis in a first direction while rotating the container about a second axis in a second direction to effect a mixing; wherein the first temperature is lower than the temperature of the mixture at the end of the mixing.

In yet another aspect, the second axis is the center axis of the container.

In one embodiment, the container is disposed at a distance from the first axis, and the second axis forms an angle with the first axis.

Other features and advantages of the present invention will become apparent from the following detailed description and claims.

### BRIEF DESCRIPTION OF THE DRAWINGS

FIG. 1 is a schematic diagram of an apparatus for carrying out a method of mixing of the present invention.

FIG. 2 shows viscosity as function of time at room temperature of two lots prepared by a method of the present invention and two lots prepared by the stirring rod method.

### DETAILED DESCRIPTION OF THE INVENTION

In general, the present invention provides a method for producing mixtures of thermally labile materials.

In one aspect, a method of the present invention requires a shorter mixing time than a conventional mixing method that uses rotating blades, but produces a mixture having substantially the same uniformity and longer work life. The method of the present invention is advantageously applicable to viscous thermally labile materials that would not tolerate long mixing time because of rapid change in their properties at elevated temperatures.

In one embodiment, a method of the present invention comprises providing, in a container, at least a first component of the mixture at a temperature lower than a reaction temperature of said at least a first component and a remaining component; adding the remaining component of the mixture to said at least a first component; subjecting the container to a rotational motion about a first axis in a first direction while rotating the container about a second axis in a second direction.

In one aspect, the reaction temperature of the components is the temperature at which the reaction is at least 95 percent complete within 4 hours.

In another aspect, the rotational speed about the first and second axes is greater than about 500 revolutions per minute (“rpm”), preferably greater than about 100 rpm, more preferably greater than about 2000 rpm. In another aspect, the rotational speed is in the range from about 2500 rpm to about 5000 rpm.

In one embodiment, the second axis is the center axis of the container. In another embodiment, the container is located at a distance from the first axis, and the second axis forms an angle with the first axis. In still another embodiment, the container is fixed to a support that is rotated about the first axis.

In one aspect, the second direction can be the same as or different than the first direction.

The components of the mixture can be reactants participating in a reaction. Alternatively, one of the components can be a catalyst that initiates or accelerates a reaction of one or more other components of the mixture.

In another embodiment, the components are polymerizable monomers or prepolymers that react when brought together to produce a polymer. A component of the mixture can be a catalyst for the polymerization reaction, such as a Pt organometallic complex for the hydrosilylation reaction, or acid or base catalysts for ring opening polymerization.

In another aspect of the present invention, a first component of the mixture is cooled to a subambient temperature such that the temperature of the mixture at the end of the mixing is about room temperature. In yet another aspect, the temperature at the end of the mixing is less than or equal to about 35° C.; preferably, less than or equal to about 30° C. Such a starting subambient temperature may be estimated from the knowledge of the desired end temperature, the amount of input power, and the heat capacities of the various components of the mixture. The first component can be cooled for a period of time sufficient to achieve the desired subambient temperature.

In another embodiment of the method of the present invention, all of the components of the mixture are cooled to a desired temperature prior to mixing.

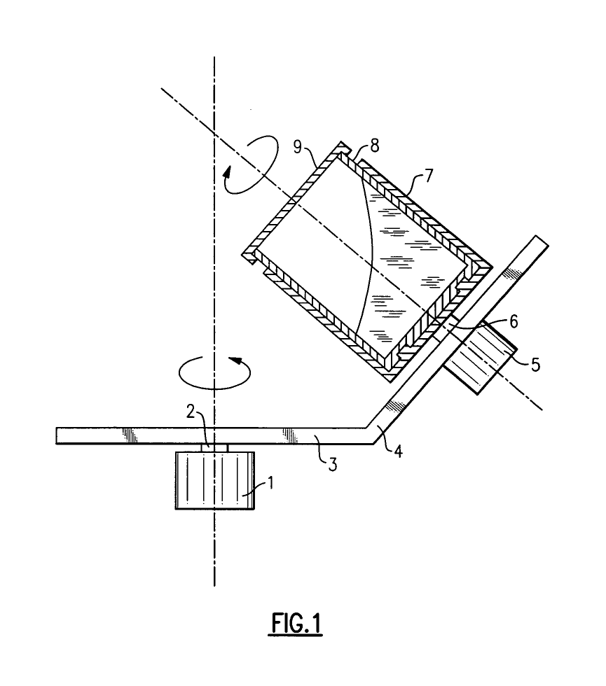

FIG. 1 is a schematic diagram showing essential elements of an embodiment of an apparatus for carrying out a method of mixing of the present invention. It should be understood that a method of the present invention is not limited by the following description of this apparatus. A main rotary shaft 2 is rotatably driven by a drive unit 1. Fixedly mounted on an upper end portion of the main drive shaft 2 is a rotary arm 3 which is provided with a raised oblique or inclined portion 4 in its distal end. A rotary drive mechanism 5 is provided for rotatably driving a rotary shaft 6 of the container 8. In one embodiment, rotary drive mechanism 5 is fixedly mounted on a lower surface of the raised oblique portion 4 of the arm 3. A suitable transmission (not shown) constructed of gears and/or belts and pulleys for transmitting torque from main rotary shaft 2 of arm 3 to rotary drive mechanism 5 of container 8 may be interposed between rotary shaft 6 of container 8 and rotary drive mechanism 5. This arrangement of rotary drive mechanism 5 allows the rotation of container 8 on its own rotary shaft 6 to be coupled to the rotational motion of arm 3.

Alternatively, rotary drive mechanism 5 can be independent from drive unit 1 of main drive shaft 2, allowing container 8 to rotate at a different rotational speed and/or direction than that of arm 3. Thus, container 8 can rotate about rotary shaft 6 at rotational speed that is the same as or different than the speed of arm 3.

The material at any point inside container 8 is acted on by a combination of two centrifugal forces: one generated by the rotation of arm 3 and one by the rotation of container 8. Since container 8 is disposed at an angle with respect to shaft 2, material at a point in the half of container 8 that is further from shaft 2 experiences a net force that is directed upward, while material at a point in the half of container 8 that is closer to shaft 2 experiences a net force that is directed downward. As a consequence, such forces generate a constant mixing motion of all of the material inside container 8. Such an apparatus is commonly termed “dual axis centrifuge.”

Non-limiting examples of other apparatuses that are also suitable for carrying out a method of the present invention are disclosed in U.S. Pat. Nos. 4,235,553; 4,497,581; 4,728,197; 5,352,037; 5,551,779; 6,099,160; 6,709,151; 6,755,565; and U.S. patent Application 2002/0172091; all of which are incorporated herein by reference.

### EXAMPLE

### Mixing and Curing of Three Components of a Polymerizable Formulation

The first component consisted of a divinyl polysiloxane prepolymer, a siloxane resin having multiple vinyl functional groups, and a Pt organometallic complex catalyst. The second component consisted of a polymerizable benzotriazole UV blocker. The third component consisted of the divinyl polysiloxane prepolymer, a crosslinker, and a cyclic siloxane cure adjuster.

Predetermined amounts of the pre-mised first and second components were weighed into a container having a volume of about 250 ml. The container and its contents were cooled overnight in a freezer to about −20° C. A predetermined amount of the third component, which was kept at room temperature, was added to the container at room temperature the next day. The container was installed in a FlackTek SpeedMixer™ DAC 400 FVZ (FackTek Inc., Landrum, S.C.), which is a dual axis centrifuge of the type described above. The contents were mixed at a speed of 2700 rpm, an acceleration factor of 500 (representing a proportionality factor of the time to steady state speed), and a total mixing time of 55 seconds. The temperature of the contents at the end of mixing was 28.4° C. It was observed that the mixture required 20-30 minutes to degas. It is believed that the material in the container was squeezed during mixing because of a downward motion generated in the container.

The same three components (all kept at room temperature prior to mixing) also were mixed in a 600-ml glass beaker equipped with a Teflon™-coated stirring rod having attached blades. This method of mixing introduced much air into the mixture, which required between 1.5 and 3 hours to degas completely. Since less degas time was required with dual axis centrifuge mixing, more time was available to work with the mixture.

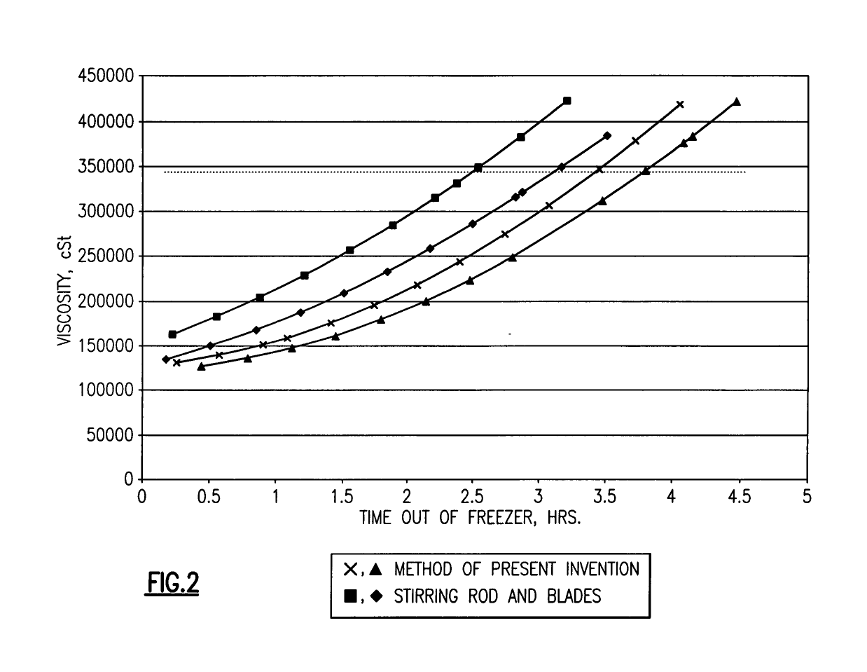

Mixtures produced in both methods were stored at −10° C. for one day. The mixtures were then allowed to stand at room temperature, and their viscosities were measured with increasing time at room temperature to calculate available work lives of the mixtures. When the viscosity reached 350,000 cSt (centistokes or mm²/s), the mixture was deemed to be unworkable. The results of the viscosity measurements for two lots using the method of the present invention and two other lots using the stirring rod method are shown in FIG. 2. The method of the present invention provides work life of about 0.5-1.5 hour longer than the stirring rod method.

The mixing method of the present invention is advantageously used to prepare polymerizable compositions for the manufacture of ophthalmic devices, such as intraocular lenses and contact lenses. For example, a mixture produced by a mixing method of the present invention can be further formed into these ophthalmic devices by molding and curing the mixture. Alternatively, the mixture can be cured to form solid articles, which are then machined and/or lathed into the final ophthalmic devices.

While specific embodiments of the present invention have been described in the foregoing, it will be appreciated by those skilled in the art that many equivalents, modifications, substitutions, and variations may be made thereto without departing from the spirit and scope of the invention as defined in the appended claims.

What is claimed is:

1. A method for producing a mixture, said method comprising:
providing, in a container, at least a first component of said mixture at a first temperature;
adding a remaining component of said mixture to said at least a first component; and
subjecting said container to a rotational motion about a first axis in a first direction while rotating said container about a second axis in a second direction to effect a mixing said components;
wherein said first temperature is lower than a temperature of said mixture at a completion of said mixing.

2. The method of claim 1, wherein said first temperature is a temperature at which a reaction between said components is at least 95 percent complete within 4 hours.

3. The method of claim 1, wherein the temperature of the mixture at the completion of said mixing is about room temperature.

4. The method of claim 1, wherein the temperature of the mixture at the completion of said mixing is less than or equal to about 35° C.

5. The method of claim 1, wherein the temperature of the mixture at the completion of said mixing is less than or equal to about 30° C.

6. The method of claim 1, wherein said container is located at a distance from said first axis.

7. The method of claim 1, wherein said second axis is a center axis of said container, and said second axis forms an angle with said first axis.

8. The method of claim 1, wherein said first direction is the same as said second direction.

9. The method of claim 1, wherein said first direction is opposite to said second direction.

10. The method of claim 1, wherein said container is fixed to a support that is rotated about said first axis.

11. The method of claim 1, wherein said container is rotated about said second axis at a rotational speed of said support.

12. The method of claim 1, wherein said container is rotated about said second axis at a rotational speed that is different than a rotational speed of said support.

13. The method of claim 1, wherein said components are polymerizable materials.

14. The method of claim 1, wherein said mixture is a polymerizable composition for a manufacture of ophthalmic devices.

15. A method of producing a mixture, said method comprising:
providing, in a container, at least a first component of said mixture at a first temperature;
adding a remaining component of said mixture to said at least a first component; and
subjecting said container to a rotational motion about a first axis in a first direction while rotating said container about a second axis in a second direction to effect a mixing said components;
wherein said first temperature is lower than a temperature of said mixture at a completion of said mixing, said container is disposed at a distance from said first axis, said first and second axis form an angle, and the first temperature is chosen such that a temperature of said mixture at a completion of said mixing is less than about 30° C.

16. A method of producing a mixture, said method comprising:
providing, in a container, at least a first component of said mixture at a first temperature;
adding a remaining component of said mixture to said at least a first component; and
subjecting said container to a rotational motion about a first axis in a first direction while rotating said container about a second axis in a second direction to effect a mixing said components;
wherein said first temperature is lower than a temperature of said mixture at a completion of said mixing, said container is disposed at a distance from said first axis, said first and second axis form an angle, the first temperature is chosen such that a temperature of said mixture at a completion of said mixing is less than about 30° C., and the rotational speed of said first and second axis is in a range from about 2500 rpm and about 5000 rpm.
